(19) United States
(12) Patent Application Publication
(10) Pub. No.: US 2015/0164061 A1
(43) Pub. Date: Jun. 18, 2015

(54) ANTI-INSECT DEVICE

(71) Applicant: ROEE GERSHON, TEL-AVIV YAFFO (IL)

(72) Inventor: ROEE GERSHON, TEL-AVIV YAFFO (IL)

(21) Appl. No.: 14/556,162

(22) Filed: Nov. 30, 2014

(30) Foreign Application Priority Data
Dec. 14, 2013 (IL) 229789

(51) Int. Cl. A01M 1/16; A01M 1/10; A01M 1/14; A01M 1/02

(52) U.S. Cl. CPC A01M 1/16; A01M 1/023; A01M 1/106; A01M 1/14

(57) ABSTRACT

An anti-insect device comprising: a strap, comprising: a disinfestation layer, comprising substance(s) for performing function(s) such as attracting insects thereto, gluing insects thereto, disinfestating insects upon contact with said disinfestation layer, rejecting insects therefrom; an adhesive layer, for adhering the disinfestation layer to an object; a first removable protecting layer, for isolating the disinfestation layer until use; and a second removable protecting layer, for isolating the adhesive layer until use; thereby upon contacting the mosquitoes with the disinfestation layer, disinfestating the mosquitoes.

### CROSS-REFERENCE TO RELATED APPLICATIONS

This application claims priority from Israel Patent Application No. 229,789, filed Dec. 4, 2013, the contents of which are incorporated herein by reference in their entirety.

### TECHNICAL FIELD

The present invention relates to the field of anti-insect devices.

### BACKGROUND

Mosquito bites and presence of insects in urban areas is a vexing problem. Presently there are available on the market spray tubes and traps useable for active and passive mosquito control, but the success is not full, and there is always a place for improvement.

Insects, whether crawling or flying, penetrate into domestic spaces through openings such as windows, doors, sink, and so on. Once the mosquitoes have succeeded to penetrate into a domestic space, their elimination is complicated.

It is an object of the present invention to provide a solution to the above-mentioned and other problems of the prior art.

Other objects and advantages of the invention will become apparent as the description proceeds.

### SUMMARY OF THE INVENTION

An anti-insect device comprising:
a strap, comprising:
   a disinfestation layer, comprising substance(s) for performing function(s) such as attracting insects thereto, gluing insects thereto, disinfestating insects upon contact with said disinfestation layer, rejecting insects therefrom;
   an adhesive layer, for adhering the disinfestation layer to an object;
   a first removable protecting layer, for isolating the disinfestation layer until use; and
   a second removable protecting layer, for isolating the adhesive layer until use;
      thereby upon contacting the mosquitoes with the disinfestation layer, disinfestating the mosquitoes.

### BRIEF DESCRIPTION OF DRAWINGS

Embodiments, features, aspects and advantages of the present invention are described herein in conjunction with the following drawings:

FIG. 1 schematically illustrates an anti-insect device, according to one embodiment of the invention.

FIG. 2 schematically illustrates strap 10 of FIG. 1, adhered along the entire extent of crossbar 34 of window 32.

FIG. 3 schematically illustrates an anti-insect device, according to one embodiment of the invention.

FIG. 4 schematically illustrates an anti-insect device, according to a further embodiment of the invention.

It should be understood that the drawings are not necessarily drawn to scale.

### DETAILED DESCRIPTION

The present invention will be understood from the following detailed description of embodiments, which are meant to be descriptive and not limiting. For the sake of brevity, some well-known features, methods, systems, procedures, components, circuits, and so on, are not described in detail.

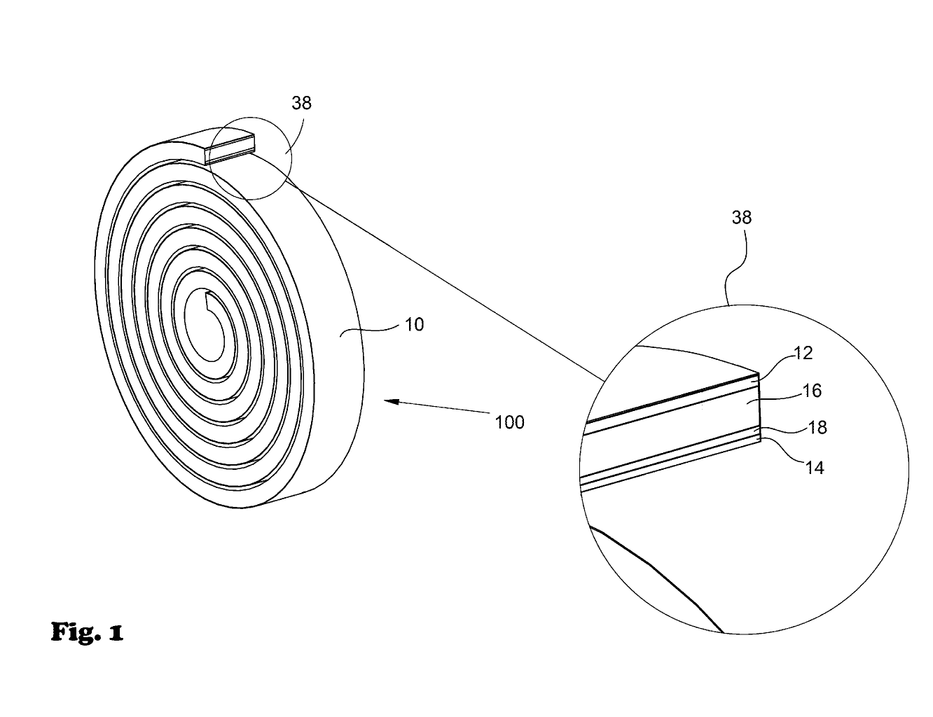

FIG. 1 schematically illustrates an anti-insect device, according to one embodiment of the invention.

The anti-insect device, which is marked herein by reference numeral 100, is in a form of a flat flexible strap 10 that comprises four layers:
(a) a disinfestation layer 16, for rejecting or attracting mosquitoes and other insects thereto, and optionally disinfestating the insects, depending on the substances that the layer is made of;
(b) an adhesive layer 18, for adhering layer 16 to an object;
(c) a removable protecting layer 12, for isolating layer 16 until use; and
(d) a removable protecting layer 14, for isolating layer 18 (the adhesive layer) until use.

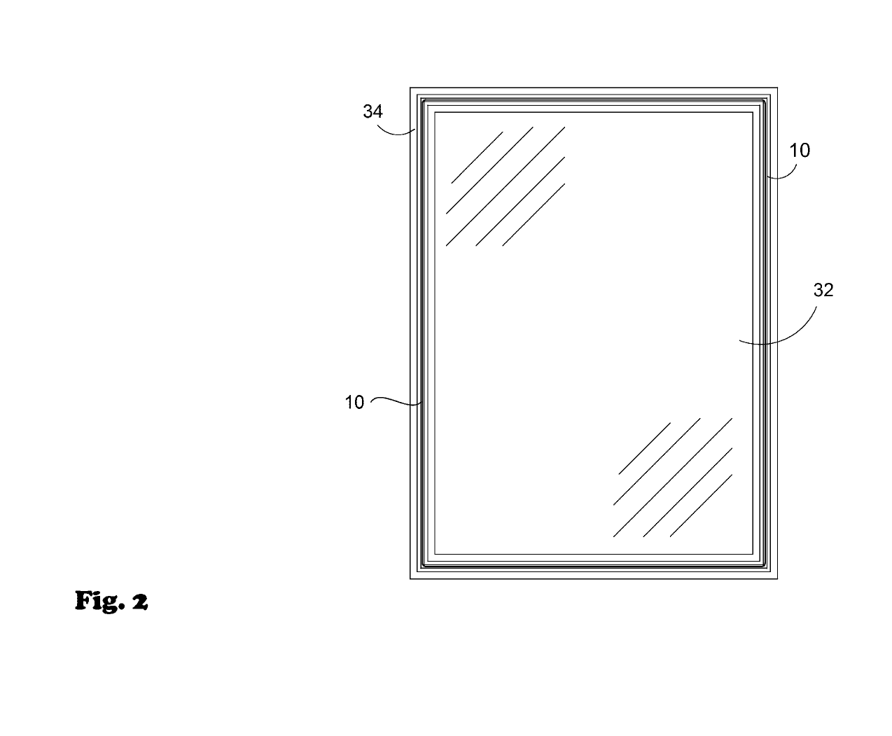

In order to use the anti-insect device, the user removes layer 14 which isolates the adhesive layer 18, and adheres the strap around an inlet to a domestic space, such as a window, a door, and so on, as illustrated in FIG. 2. Then he removes layer 12, which isolates the disinfestation layer 16, thereby exposing the disinfestation layer 16.

The disinfestation may comprise a combination of materials that provide the following functionalities:
attracting mosquitoes thereto;
gluing mosquitoes thereto; and
liquidating attracted mosquitoes.

For example, each of “agar-agar” and “gelatin E441” can be used for attracting mosquitoes thereto, and chlorinated hydrocarbons can be used for liquidating the mosquitoes.

The disinfestation layer (16) may also comprise the following materials for rejecting insects and mosquitoes: DEET, PICARIDINE, IR3535, and PMD. These materials are confirmed by the EPA—the US Environmental Protection Agency, and also are confirmed by the Israeli authorities as safe to use materials.

Gelatin (or gelatine) is a translucent, colorless, brittle (when dry), flavorless solid substance, derived from collagen obtained from various animal by-products. It is commonly used as a gelling agent in food, pharmaceuticals, photography, and cosmetic manufacturing. (From Wikipedia). Gelatin is often marled as E441.

Agar or agar-agar is a gelatinous substance, obtained from algae and discovered in 1658 by Minora Tanzaemon in Japan, where it is called Kanten. (from Wikipedia)

The factor that attracts mosquitoes in this example is the smell.

Thus, when the disinfestation layer of strap 10 is attached on the extent of an inlet to a domestic space, it attracts mosquitoes that intend to enter into the domestic space, and one they touch the disinfestation layer, they are liquidated.

According to an embodiment of the invention, the strap is manufactured in a roller form, as illustrated in the figure.

According to another embodiment of the invention, the strap is manufactured in linear segments.

FIG. 2 schematically illustrates strap 10 of FIG. 1, adhered along the entire extent of crossbar 34 of window 32.

The disinfestation strap rejects and even disinfests mosquitoes and other insects, thereby prevents them to enter into the window's room, even when the window is open.

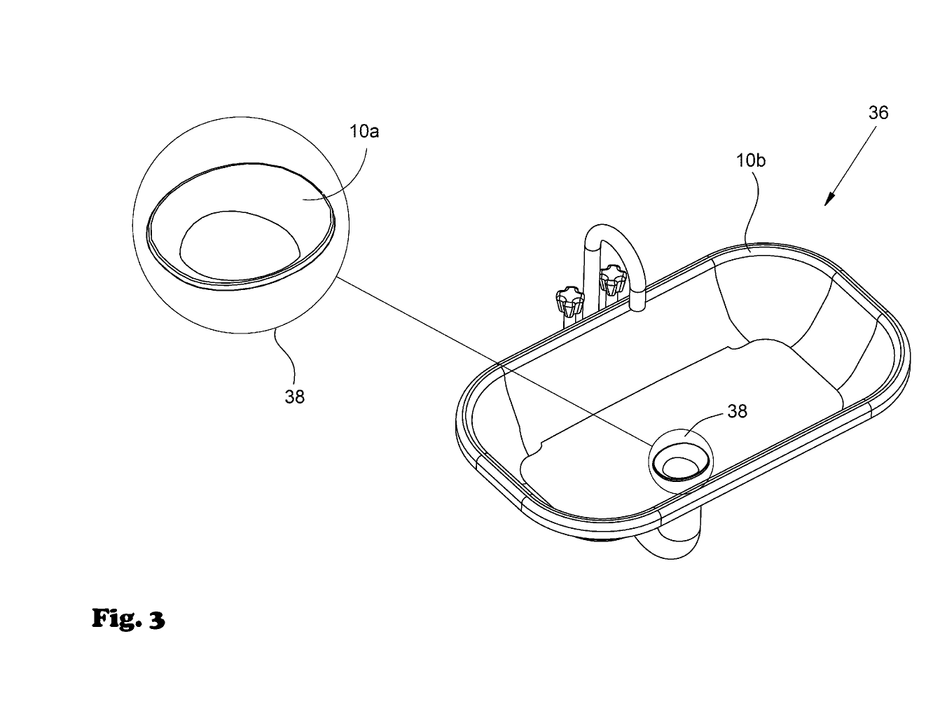

FIG. 3 schematically illustrates an anti-insect device, according to one embodiment of the invention.

The figure illustrates two types of straps: a strap 10a, which has a conic form, to be adhered to an opening of a sink 36, which in this case is the outlet of the sink; and a strap 10b, which is in a form of the strap of FIG. 1, and adhered to the edge (inlet) of sink 36.

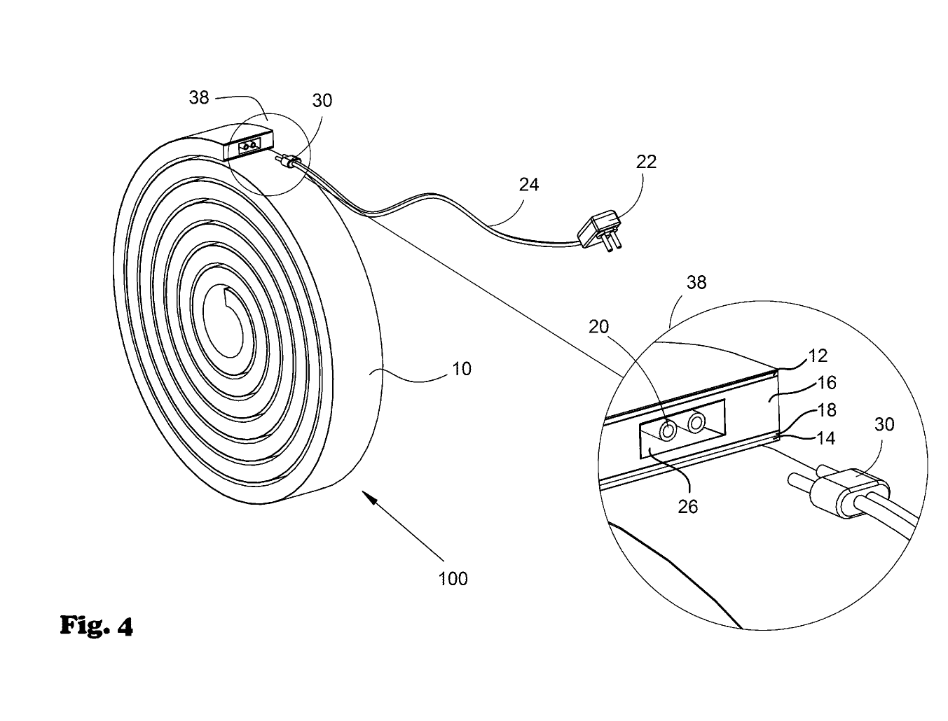

FIG. 4 schematically illustrates an anti-insect device, according to a further embodiment of the invention.

According to this embodiment of the invention, a filament 20 passes through or near the disinfestation layer. The filament is heated and retained at 37 centigrade, which is a human body temperature to which mosquitoes are attract to. The element in charge of heating and retaining the temperature of the filament is a circuitry 30, which on one hand receives electric power from plug 22, and on the other hand connects with filament 20.

Circuitry 30 may comprise a thermostat, a combination of a thermometer and a controller, and so on. As such a circuitry is presently well known, and therefore it is not described herein in details.

Thus, according to one embodiment of the invention, the present invention is directed to an anti-insect device (100) comprising:
a strap (10), comprising:
   a disinfestation layer (16), comprising substance(s) for performing function(s) such as attracting insects thereto, gluing insects thereto, disinfestating insects upon contact with said disinfestation layer, rejecting insects therefrom;
   an adhesive layer (18), for adhering the disinfestation layer (16) to an object;
   a first removable protecting layer (12), for isolating the disinfestation layer (16) until use; and
   a second removable protecting layer (14), for isolating the adhesive layer (18) until use;
thereby upon contacting the mosquitoes with the disinfestation layer, disinfestating the mosquitoes.

According to one embodiment of the invention, the disinfestation layer (16) comprises chlorinated hydrocarbons, for carrying out the disinfestating function.

According to one embodiment of the invention, the disinfestation layer (16) comprises agar-agar, for carrying out the attracting and gluing functions.

According to one embodiment of the invention, the disinfestation layer (16) comprises: gelatin E441, for carrying out the attracting and gluing functions.

The disinfestation layer (16) may comprise the following materials for rejecting insects and mosquitoes: DEET, PICARIDINE, IR3535, and PMD. These materials are confirmed by the EPA—the US Environmental Protection Agency, and also are confirmed by the Israeli authorities as safe to use materials.

The anti-insect device may be manufactured in a roller form, as linear segments, in a conic form, and so on.

The anti-insect device may further comprise:

a filament (20) along the strap (10);

a circuitry (30), for heating the strap (10) to 37 centigrade, and retaining this temperature;

thereby attracting mosquitoes to the strap, thereby upon contacting with the disinfestation layer, disinfestating the mosquitoes.

The circuitry may comprise a thermostat, a combination of a thermometer and a controller, and so on.

In the figures and/or description herein, the following reference numerals (Reference Signs List) have been mentioned:
numeral 100 denotes an anti-insect device, according to one embodiment of the invention;
each of numerals 10, 10a and 10b denotes a strap;
numeral 12 denotes a removable protective layer on one side of strap 10;
numeral 14 denotes a removable protective layer on the other side of strap 10;
numeral 16 denotes a disinfestation layer of strap 10, for attracting and disinfestating mosquitoes and other insects;
numeral 18 denotes an adhesive layer of strap 10, for adhering strap 10 to an object such as a crossbar of a window or door;
numeral 20 denotes a filament, for heating strap 10;
numeral 22 denotes a plug to be plugged to a domestic power sources, for providing electric power to filament 20;
numeral 24 denotes an electric cable;
numeral 26 denotes a conduit along strap 10;
numeral 30 denotes a circuitry for heating filament 20 to 37 centigrade, and retaining this temperature;
numeral 32 denotes a window;
numeral 34 denotes a crossbar of window 32;
numeral 36 denotes a domestic sink; and
numeral 38 denotes a zoomed view.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

What is claimed is:

1. An anti-insect device comprising:
a strap, comprising:
a disinfestation layer, comprising material(s) for performing function(s) selected of a group consisting of: attracting insects thereto, gluing insects thereto, disinfestating insects upon contact with said disinfestation layer, rejecting insects therefrom;
an adhesive layer, for adhering said disinfestation layer to an object;
a first removable protecting layer, for isolating said disinfestation layer until use; and
a second removable protecting layer, for isolating said adhesive layer until use;
thereby upon contacting said mosquitoes with said disinfestation layer, disinfestating said mosquitoes.

2. An anti-insect device according to claim 1, wherein said disinfestation layer comprises:
chlorinated hydrocarbons, for carrying out said disinfestating function.

3. An anti-insect device according to claim 1, wherein said disinfestation layer comprises:
agar-agar, for carrying out said attracting and gluing functions.

4. An anti-insect device according to claim 1, wherein said disinfestation layer comprises:
gelatin E441, for carrying out said attracting and gluing functions.

5. An anti-insect device according to claim 1, wherein said disinfestation layer comprises a substance selected from a group comprising: DEET, ICARIDINE, IR3535, PMD, for carrying out said insect rejecting function.

6. An anti-insect device according to claim 1, manufactured in a roller form.

7. An anti-insect device according to claim 1, manufactured in linear segments.

8. An anti-insect device according to claim 1, manufactured in a, conic form.

9. An anti-insect device according to claim 1, further comprising:
a filament along said strap;
a circuitry, for heating said strap to 37 centigrade, and retaining this temperature;
thereby attracting mosquitoes to said strap, and upon contacting with said disinfestation layer, disinfestating said mosquitoes.

10. An anti-insect device according to claim 9, wherein said circuitry comprises a member of a group consisting of: thermostat, a combination of a thermometer and a controller.
